(19) United States
(12) Patent Application Publication
(10) Pub. No.: US 2003/0204749 A1
(43) Pub. Date: Oct. 30, 2003

(54) Security system

(75) Inventors: Alan Pugh, Berkshire (GB); Akira Atsuta, Berkshire (GB)

Correspondence Address: GREENBLUM & BERNSTEIN, P.L.C., 1950 ROLAND CLARKE PLACE, RESTON, VA, 20191, US

(73) Assignee: MATSUSHITA GRAPHIC COMMUNICATION SYSTEMS, INC, Tokyo (JP)

(21) Appl. No.: 10/184,940

(22) Filed: Jul. 1, 2002

(30) Foreign Application Priority Data
Apr. 30, 2002 (GB) 0209895.2

(51) Int. Cl. H04L 9/00

(52) U.S. Cl. 713/201

(57) ABSTRACT

A security system that protects an apparatus from (e.g. theft) comprises at least one secured apparatus having an identification code, an operation center having a memory with the identification code of the secured apparatus stored in association with an operation-permitting code and a gateway apparatus connecting the secured apparatus and the operation center. The gateway apparatus and the operation center are connected via a permanently connectable line, which is not subject to connection time charges. When the secured apparatus is turned on, the secured apparatus transmits the identification code to the operation center via the line. Then, the operation center searches the table for an operation-permitting code corresponding to the identification code, and transmits the operation-permitting code retrieved from the memory to the secured apparatus via the line, if the operation-permitting code corresponding to the identification code is found.

### BACKGROUND OF THE INVENTION

1. Field of the Invention

This invention relates to a security system and more specifically to a security system for protecting consumers' apparatuses from theft.

2. Description of Related Art

U.S. Pat. No. 5,729,596 describes a technology relating to a security system, in which an interface is used between a home electrical power and PSTN line to provide identification codes to secured apparatuses from a distant operation center. Secured apparatuses include a television set, video recorder, and hi-fi apparatus for example, and each apparatus is allowed to operate upon receiving its identification code.

In particular, each secured apparatus requests an identification code every time the main power is connected to the apparatus. Then, the interface to the PSTN recognizes the request from the apparatus and establishes a telephone call to a security control center via the PSTN. The security control center then detects the location of the apparatus requesting for the identification code, e.g., a home. Further, the identification code transmitted to the specified home by the security control center is compared with the identification code within the secured apparatus. When the codes match, the power supply for the operation circuit of the apparatus is permitted, and when they do not match, the power supply for the operation circuit is blocked.

The above-mentioned conventional security system is able to protect each apparatus against theft. However such system increases the traffic of the PSTN, since a call is generated to the PSTN for every connection made between the secured apparatus and electrical power. Further, the conventional system increases the cost charged to the consumers because of the frequent communications with the PSTN. Furthermore, there is a need for each secured apparatus at a home to have installed a program that compares the identification code transmitted from the security control center with the identification code stored within the apparatus, since it is up to the individual apparatus to make a determination whether the identification codes match.

In order to solve the problem, EP 960,407 proposes a technology with which the home control center is installed at home to provide the identification code of each apparatus. This method is successful in eliminating the process of making a call to the PSTN for every connection made between the apparatus and the electrical power. However, the home control center must store all of the identification codes corresponding to the apparatuses in the home. Therefore, the number of secured apparatuses is limited according to the memory size within the home control center.

### SUMMARY OF THE INVENTION

The object of the present invention is to provide a security system in which a home control center is not required to have a memory that stores the identification code of each apparatus, and the cost for the consumers does not increase.

According to the present invention, secured apparatuses are connected to an office operation center using a line that has a fixed access fee, instead of the PSTN, such as a DSL or cable line. In addition, the office operation center is provided with a large database in which identification codes for all of the secured apparatuses at home are preregistered.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block schematic diagram illustrating a security system according to an embodiment of the present invention;

FIG. 2 is a block diagram illustrating a home control gateway apparatus that is used in the security system according to the present embodiment;

FIG. 3 is a signal sequence chart for registering a new apparatus to be secured in the security system according to the present embodiment;

FIG. 4 is a signal sequence chart for turning on the registered secured apparatus in an appropriate location within the security system according to the present embodiment; and

FIG. 5 is a signal sequence chart for turning on a registered secured apparatus in an inappropriate location.

### DETAILED DESCRIPTION OF PREFERRED EMBODIMENTS

The embodiment of the present invention is explained in the following, in reference to the above-described drawings.

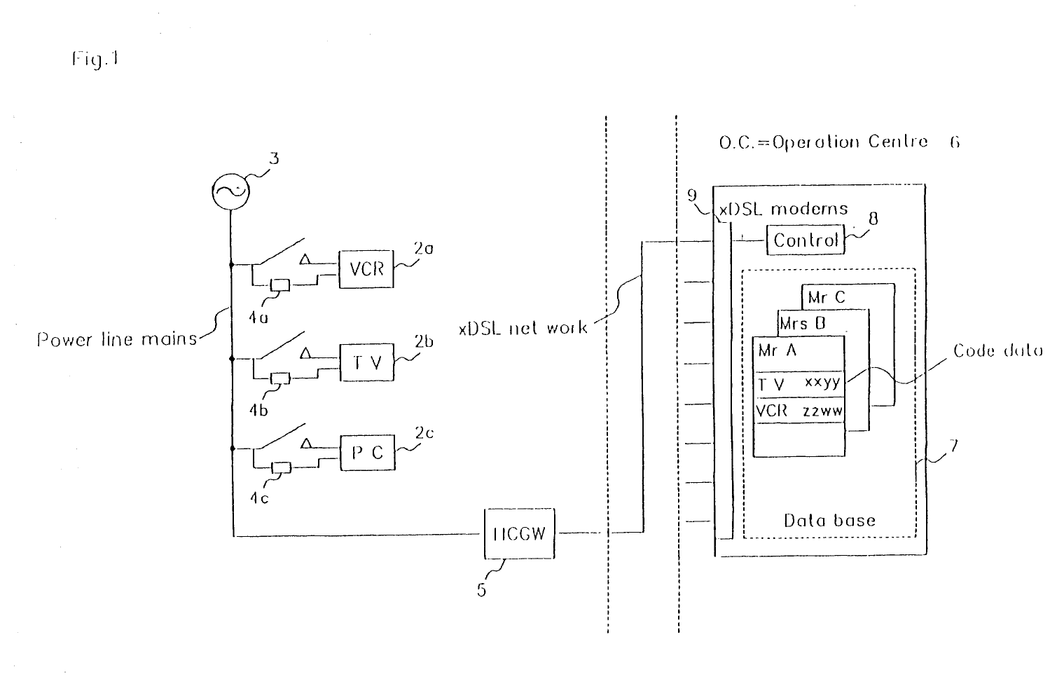

FIG. 1 is a block schematic diagram illustrating a security system according to an embodiment of the present invention. At home 1, secured apparatuses such as VCR apparatus 2a, TV set 2b, PC 2care connected to electrical power 3 via a power line. 4a-4c are power line modems that are attached to the secured apparatuses, and that transmit an identification code received from each apparatus when it is turned on, to home control gateway 5. A switch circuit installed to each secured apparatus is normally open, and temporarily closes when the secured apparatus is turned on so that the apparatus becomes operational.

Operation center 6 includes large capacity database 7. Database 7 maintains identification codes of secured apparatuses and manages them for each home. An individual identification code includes at least information that specifies a secured apparatus. Code information is described in detail in EP 960,407, the disclosure of which is incorporated herein in its entirety. Operation center 6 further includes controller 8 and xDSL modem 9. Operation center 6 is connected to home control gateway 5 at home via xDSL network. Secured apparatuses 2a-2c and operation center 6 have a permanent connection via the xDSL network.

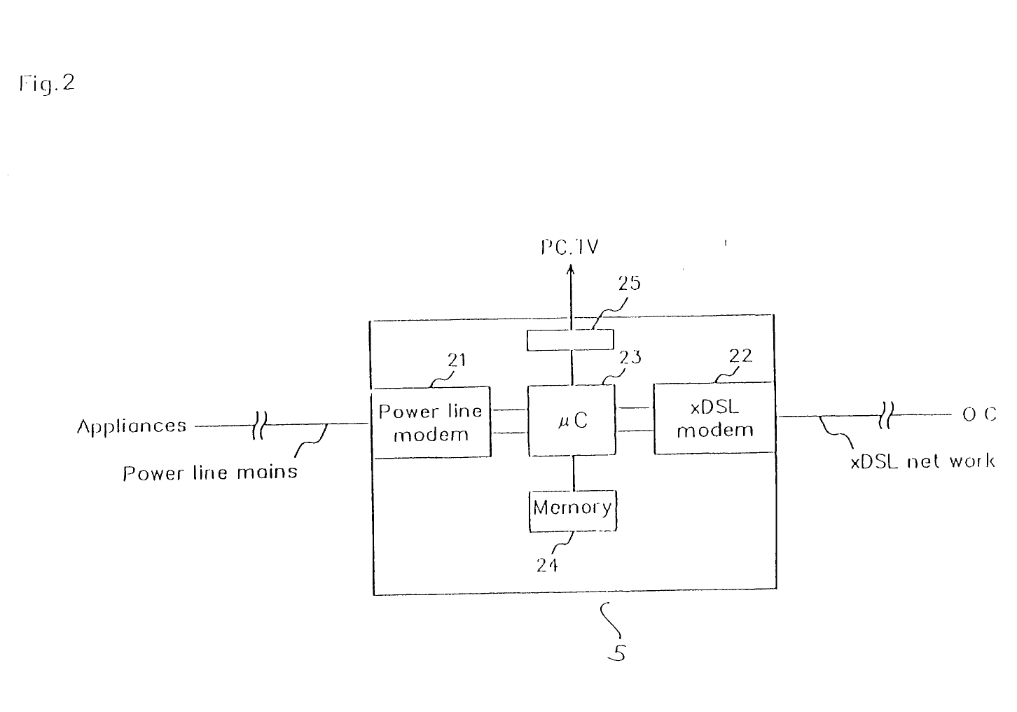

FIG. 2 is a block diagram illustrating home control gateway 5. Home control gateway 5 at least includes power line modem 21 that perform communications with power line modems 4a-4c within secured apparatuses via the power line, xDSL modem 22 that performs communications with operation center 6 via the xDSL network, microprocessor 23 that controls the entire apparatus, and memory 24 that stores various programs. Data interface 25 is also included in home control gateway 5 so that TV set 2b, PC 2c or the like can perform communication using the xDSL network.

Although home control gateway 5 is installed to connect the power line and the xDSL network in this embodiment, such an interface can be installed within individual secured apparatuses 2a-2c.

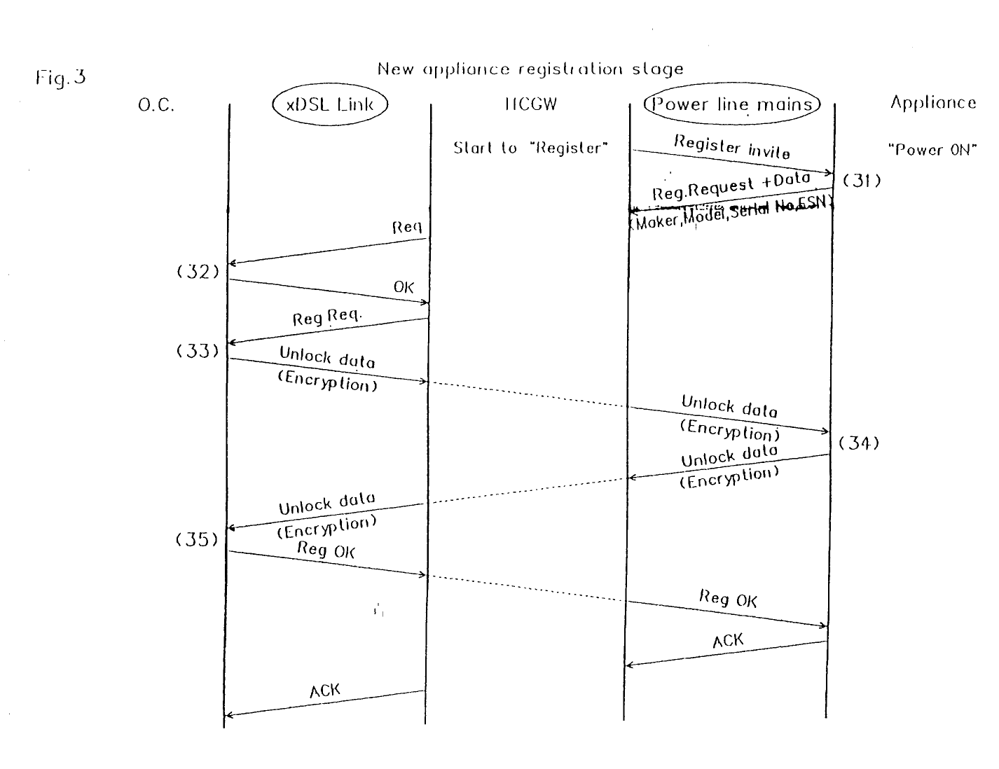

FIG. 3 is a signal sequence chart for registering a new apparatus to be secured in operation center 6, after a user purchases the apparatus. First, the user requests for a registration of the new to-be-secured apparatus using an operational key (not shown) in home control gateway 5. With this registration request, home control gateway 5 transmits a “register invite” signal to the to-be-secured apparatus, which is turned on (Step 31), and receives an identification code specifying the to-be-secured apparatus from the apparatus. Such identification code can include information that specifies the apparatus, such as its manufacturer, model, and type (e.g., TV, PC, etc.). Upon receiving this information, home control gateway 5 connects to operation center 6 using the xDSL network to which home control gateway 5 is already connected, and transmits a request signal (Step 32). This request signal is a signal for operation center 6 to identify home control gateway 5.

When home control gateway 5 receives an OK signal from operation center 6, which approves home 1, home control gateway 5 transmits a registration request signal to operation center 6 (Step 33). This signal includes the identification code that was previously transmitted by the to-be-secured apparatus. When operation center 6 receives the identification code, operation center 6 generates an unlock code with which the to-be-secured apparatus becomes operational, and transmits the unlock code to the to-be-secured apparatus via the xDSL network and home control gateway 5 (Step 34). Simultaneously, operation center 6 stores the identification code transmitted by the to-be-secured apparatus and the unlock code, in association with the identified home control gateway 5 at Step 33.

It is preferable to encrypt the unlock code that is transmitted to the to-be-secured apparatus, since the code has a significant importance for the security of the apparatus. Then, the to-be-secured apparatus transmits the unlock code back to operation center 6 via the xDSL network and home control gateway 5 (Step 35). Accordingly, operation center 6 can confirm that the unlock code is registered in the to-be-secured apparatus. Upon receiving the returned signal, operation center 6 transmits a confirmation signal to the to-be-secured apparatus, and receives an ACK signal from the to-be-secured apparatus to complete the series of registration operations.

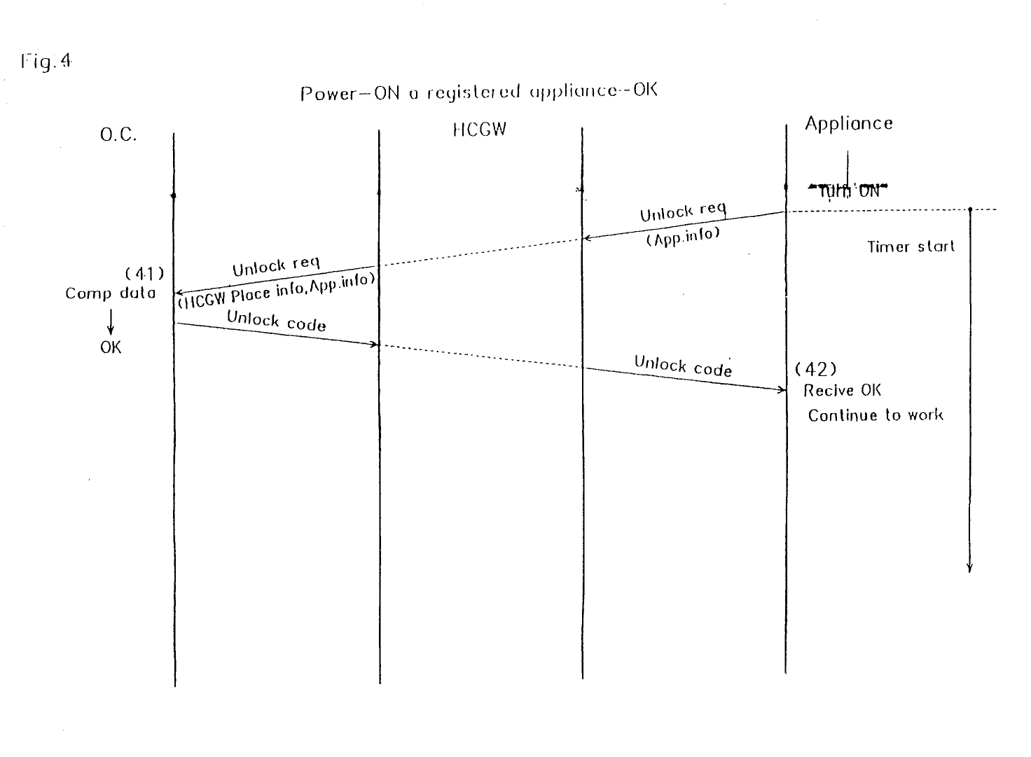

FIG. 4 illustrates the situation when a secured apparatus is operated in an appropriate location, where the apparatus is connected to the appropriate home control gateway 5 after the registration operation.

In FIG. 4, when a registered secured apparatus is turned on, the switch circuit installed in the secured apparatus closes to start supplying the power. Simultaneously, the microprocessor transmits an unlock request signal via power line modem 4a-4c. This signal is transmitted to operation center 6 via the power line and home control gateway 5 (Step 41). The unlock request signal includes the identification code specifying the secured apparatus, and home control gateway 5 adds data specifying the home control gateway 5 to this signal. Upon receiving the signal, operation center 6 searches its own database 7 for the corresponding home (home control gateway 5) and the identification code of the secured apparatus. These search operations are controlled by controller 8. If the received identification code matches with the identification code in the database, i.e., when it is recognized that the secured apparatus is registered at home, the unlock code corresponding to the identification code is retrieved and transmitted to the secured apparatus via xDSL network (Step 42). Once the unlock code is received, the secured apparatus can continue to have the power supply. Specifically, the switch remains closed under the control of a microprocessor of the secured apparatus, and the apparatus becomes operational when the unlock code is received. Since an identification code is transmitted to operation center 6 via the xDSL network every time the secured apparatus is turned on, there is no need to consider the cost of communication via the PSTN as in the conventional method. Additionally, since the identification codes are stored in the large capacity database of operation center 6, it is possible to store the identification codes without limiting the number of secured apparatuses.

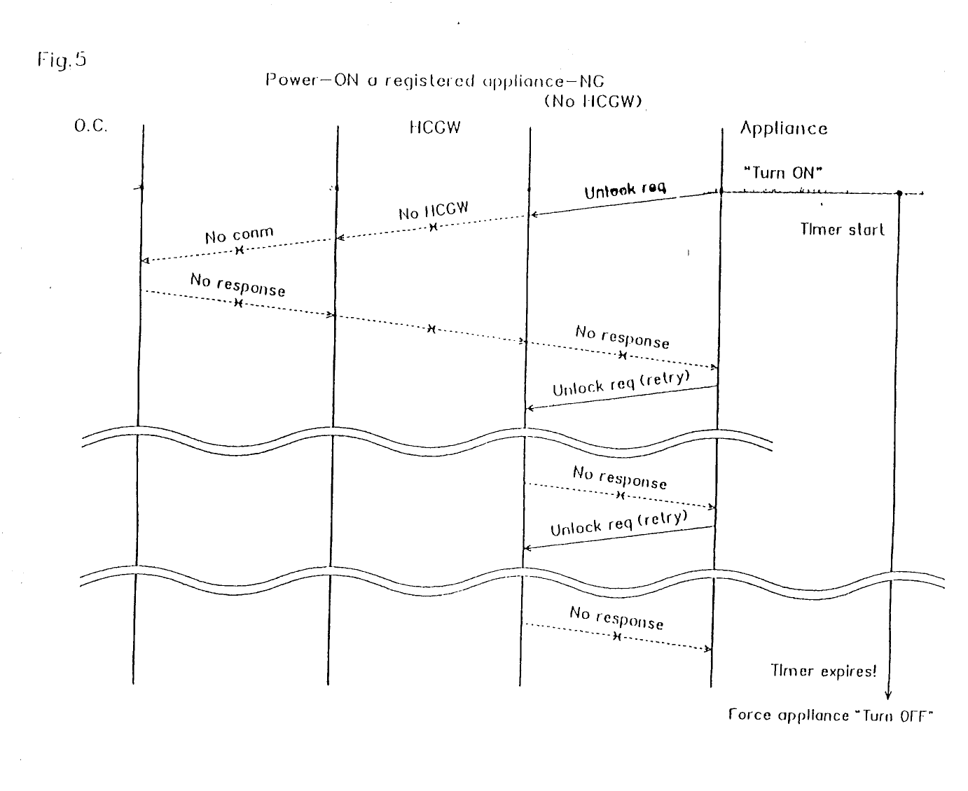

Next, an example of activating the security system is illustrated. FIG. 5 illustrates the example of turning on a secured apparatus in an inappropriate location because of theft or the like. When the secured apparatus is turned on, the apparatus transmits an unlock request signal similarly to FIG. 4. However, since the apparatus is turned on in an inappropriate location, home control gateway 5 is not installed. Therefore, a response signal is not generated in response to the transmitted unlock request signal. If the response signal is not received within a certain time period, the secured apparatus transmits another unlock request signal, but the response signal will never be generated. Upon expiration of a predetermined time period, set by a use of a timer (not shown), which has been started when the secured apparatus is turned on, the switch circuit in the secured apparatus opens and the secured apparatus becomes inoperative.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

The present invention is not limited to the above-described embodiments, and various variations and modifications may be possible without departing from the scope of the present invention.

What is claimed is:

1. A security system protecting an apparatus comprising:
at least one secured apparatus having an identification code;
an operation center having a memory with the identification code of said secured apparatus stored in association with an operation-permitting code; and
a gateway apparatus connecting the secured apparatus and said operation center, said gateway apparatus and said operation center being connected via a permanently connectable line, to which connection time charges do not apply,
wherein, when said secured apparatus is turned on, said secured apparatus transmits the identification code to said operation center via the line,
wherein, said operation center searches the memory for an operation-permitting code corresponding to the identification code, and transmits the operation-permitting code retrieved from the memory to said secured apparatus via the line, if the operation-permitting code corresponding to the identification code is found in the memory.

2. The security system of claim 1, wherein said operation center does not transmit an operation-permitting code, if an operation-permitting code that corresponds to the transmitted identification code does not exist within the memory.

3. The security system of claim 1, wherein said secured apparatus is maintained in an operational condition, when said secured apparatus receives the operation-permitting code.

4. The security system of claim 2, wherein power supply to said secured apparatus is stopped, if said secured apparatus does not receive the operation-permitting code.

5. The security system of claim 1, wherein the permanently connectable line is an xDSL network.

6. The security system of claim 1, wherein the permanently connectable line is a cable network.

7. The security system of claim 1, wherein said gateway apparatus is connected to a plurality of secured apparatuses.

8. The security system of claim 1, wherein said secured apparatus comprises a power line modem, via which said secured apparatus transmits the identification code to said operation center when said secured apparatus is turned on.

9. The security system of claim 2, wherein said secured apparatus comprises a switch circuit that opens to stop the power supply, if said secured apparatus does not receive the operation-permitting code from said operation center within a predetermined time period.

10. The security system of claim 1, wherein said operation center is connected to a plurality of gateway apparatuses via the xDSL network.

11. The security system of claim 10, wherein the memory within said operation center maintains identification codes and operation-permitting code of secured apparatuses connected to gateway apparatuses for each of said plurality of gateway apparatus.

12. A security system protecting an apparatus from theft comprising:
at least one secured apparatus having an identification code;
an operation center having a memory with the identification code of said secured apparatus stored in association with an operation-permitting code; and
a permanently connectable line connecting said secured apparatus and said operation center, the line not having connection time fees,
wherein, when said secured apparatus is turned on, said secured apparatus transmits the identification code to said operation center via the line,
wherein said operation center searches the memory for an operation-permitting code corresponding to the identification code and transmits the operation-permitting code retrieved from the memory to said secured apparatus via said line, if the operation-permitting code corresponding to the identification code is found in the memory.

13. A security system method for protecting an apparatus, the security system comprising at least one secured apparatus having an identification code, an operation center having a memory with the identification code of the secured apparatus stored in association with an operation-permitting code, and a gateway apparatus connecting the secured apparatus and the operation center, the method comprising:
transmitting the identification code to the operation center via a line from the secured apparatus when the secured apparatus is turned on, the line being a permanently connectable line and not being subject to connection time fees;
searching the table for an operation-permitting code corresponding to the identification code; and
transmitting the operation-permitting code retrieved from the memory to the secured apparatus via the line, if the operation-permitting code corresponding to the identification code is found within the memory.

14. The security system method of claim 13, wherein the operation center does not transmit an operation-permitting code, if an operation-permitting code that corresponds to the transmitted identification code is not found within the table.

15. The security system method of claim 13, wherein the secured apparatus is maintained in an operational condition, when the secured apparatus receives an operation-permitting code.

16. The security system method of claim 14, wherein power supply to the secured apparatus is stopped, if the secured apparatus does not receive an operation-permitting code.

17. The method of setting up a security system for protecting an apparatus, the security system comprising at least one secured apparatus having an identification code, an operation center having a memory with the identification code of the secured apparatus stored in association with an operation-permitting code, and a gateway apparatus connecting the secured apparatus and the operation center, the method comprising:
transmitting the identification code to the operation center via a line from the secured apparatus, when a new apparatus to be secured, that is not registered in the table, is turned on, the line being a permanently connectable line and not being subject to connection time charges;
generating an operation-permitting code corresponding to the identification code, and registering the operation-permitting code in the memory in association with the identification code, the identification code and the operation-permitting code being maintained by the gateway apparatus managing the apparatus to be secured; and
transmitting the operation-permitting code to the new apparatus to be secured via the line and maintaining the code as data for continuing power supply to the apparatus to be secured.

18. The method of setting up a security system for protecting an apparatus, the security system comprising at least one secured apparatus having an identification code, and an operation center having a memory with the identification code of the secured apparatus stored in association with an operation-permitting code, the method comprising:
transmitting the identification code to the operation center via a line by the secured apparatus, when a new apparatus to be secured that is not registered in the memory is turned on, the line being a permanently connectable line and not being subject to connection time charges;
generating an operation-permitting code corresponding to the identification code, and registering the operation-permitting code in the table in association with the identification code; and
transmitting the operation-permitting code to the new apparatus to be secured via the line and maintaining the code as data for continuing power supply to the apparatus to be secured.
